(19) United States
(12) Patent Application Publication
(10) Pub. No.: US 2004/0114020 A1
(43) Pub. Date: Jun. 17, 2004

(54) Method of, and arrangement for, feeding a printer with individual sheets

(75) Inventor: Josef Widmer, Wikon (CH)

Correspondence Address: OLIFF & BERRIDGE, PLC, P.O. BOX 19928, ALEXANDRIA, VA, 22320, US

(73) Assignee: HUNKELER AG, Wikon (CH)

(21) Appl. No.: 10/647,532

(22) Filed: Aug. 26, 2003

(30) Foreign Application Priority Data
Aug. 30, 2002 (EP) 02 019 426.2

(51) Int. Cl. B41J 2/01

(52) U.S. Cl. 347/104

(57) ABSTRACT

A paper web (8) drawn off from a supply roll is periodically moved past a rotary cutting device (12), by an advancement arrangement (11), at an advancement speed (v1), which is equal to the sheet draw-in speed (v3) of the sheet draw-in arrangement (3) of a high-speed printer (2). Said rotary cutting device severs in each case one individual sheet (31) from the moving paper web (8). This individual sheet is received by a conveying device (13), which leads the individual sheet (31) to the sheet draw-in arrangement (3) at a constant speed, i.e. at a conveying speed (v2), which is likewise equal to the draw-in speed (v3) of the sheet draw-in arrangement (3). Each individual sheet (31) cut off from the paper web (8) thus already moves at the draw-in speed (v3) of the sheet draw-in arrangement (3) at the point in time at which it is cut off, and it maintains this speed until it runs into the printing unit of the high-speed printer (2).

The invention relates to a method of, and to an arrangement for, feeding a printer with individual sheets according to the preamble of claims 1 and 8, respectively.

An arrangement of this type for feeding a laser printer is known from U.S. Pat. No. 5,751,298. This arrangement comprises an unwinding station, with a rotatably mounted supply roll formed by a wound-up paper web, an advancement arrangement, which comprises two conveying rollers and is intended for advancing the paper web, a cutting apparatus and a sheet-conveying unit having a belt conveyor. The cutting apparatus, which is arranged between the advancement arrangement and the sheet-conveying unit, has a cutting blade which can be displaced in a translatory manner, in a plane running transversely to the advancement direction of the paper web, between a standby position and a cutting position. The advancement arrangement and the belt conveyor of the sheet-conveying unit are periodically switched on on account of a control command and brought to a standstill again following a certain period of time. The cutting apparatus likewise operates discontinuously and severs a sheet from the paper web in each case when the latter is at a standstill.

As a first individual sheet is conveyed through the printing unit of the printer, a new, second individual sheet is in a first standby position, in which it is located in the region of action of the belt conveyor which belongs to the sheet-conveying unit and is at a standstill at this point in time, the sheet-conveying unit being spaced apart from the sheet draw-in arrangement of the printer. The paper web, which is likewise at a standstill at this point in time, is advanced by the advancement device to the extent where it projects beyond the cutting apparatus by the length of the next, third individual sheet which is to be severed. In this case, the leading edge of the paper web is located in the region of action of the belt conveyor of the sheet-conveying unit. As the first individual sheet is still running through the printer, the stationary paper web is severed by the cutting apparatus and the third individual sheet is thus cut off from the paper web.

Once the first individual sheet is at the point of leaving the printing unit of the printer, the belt conveyor of the sheet-conveying unit and the advancement arrangement for the paper web are briefly set in operation. The belt conveyor advances, on the one hand, the second individual sheet from the first standby position into a second standby position, in which the second individual sheet is located in the region of action of the now stationary sheet draw-in arrangement of the printer, and, on the other hand, the third individual sheet into the first standby position, previously assumed by the second individual sheet. In addition, the paper web is advanced by the advancement arrangement by the length of the next, fourth individual sheet which is to be severed. Once the second and third individual sheets have reached their corresponding standby positions, the belt conveyor and the advancement arrangement are brought to a standstill again.

If the printer signals that the next sheet is to be printed, then its sheet draw-in arrangement and the cutting apparatus are activated. The second individual sheet is conveyed to the printing unit of the printer and the stationary paper web is severed.

Just before printing of the second individual sheet has been completed, the belt conveyor of the sheet-conveying unit and the advancement arrangement for the paper web are briefly set in operation again in order for the next, waiting individual sheets to be advanced, as has been described above, by a predetermined distance.

In the case of this known arrangement, the individual sheets, once cut off from the paper web, are moved intermittently in two steps to the sheet draw-in arrangement of the printer. This means that the individual sheets are accelerated and braked between the operations of being cut off and received by the sheet draw-in arrangement of the printer. Since the supporting table of the sheet-conveying unit has to be designed for accommodating two individual sheets, it has a correspondingly long overall length.

U.S. Pat. No. 3,718,394 discloses a copier which has an internal paper roll integrated in the copier and an internal, integrated cutting arrangement. Individual sheets of variable length are cut off from the paper roll by the cutting arrangement, conveyed to the exposure drum by a conveying belt and then provided with the image which is to be copied. The conveying belt acts as an intermediate store on which severed individual sheets are stored temporarily before they reach the exposure drum. Since the cutting arrangement is an internal one adapted to the copier, it is not possible for external printers to be supplied with individual sheets.

The object of the present invention, then, is to provide a method and an arrangement of the type mentioned in the introduction which make it possible, with the lowest possible design outlay, to feed individual sheets to a printer at high speed and with precise timing.

This object is achieved according to the invention by a method having the features of claim 1 and by an arrangement having the features of claim 8.

Since the severing of an individual sheet from the paper web takes place in each case as the paper web runs past the severing device at the sheet draw-in speed of the printer, and the severed individual sheets are conveyed to the printer at this sheet draw-in speed, it is possible to feed the individual sheets to the printer in a careful manner and with precise timing, since braking and acceleration of the individual sheets are dispensed with. The arrangement for preparing and feeding the individual sheets has a short overall length and may be of comparatively straightforward design. It is adapted, in particular, to digital printers, since these use a control command in each case to request an individual sheet, which has to reach the sheet draw-in means within a certain time frame once the control command has been sent. According to the invention, a cut-off sheet reaches the draw-in means following a predetermined, constant time delay, which is independent of the format length and the spacing from any further sheets, once the control command has been sent.

Preferred further configurations of the method according to the invention and of the arrangement according to the invention form the subject matter of the dependent claims.

The invention is explained in more detail hereinbelow with reference to the drawings, in which, purely schematically:

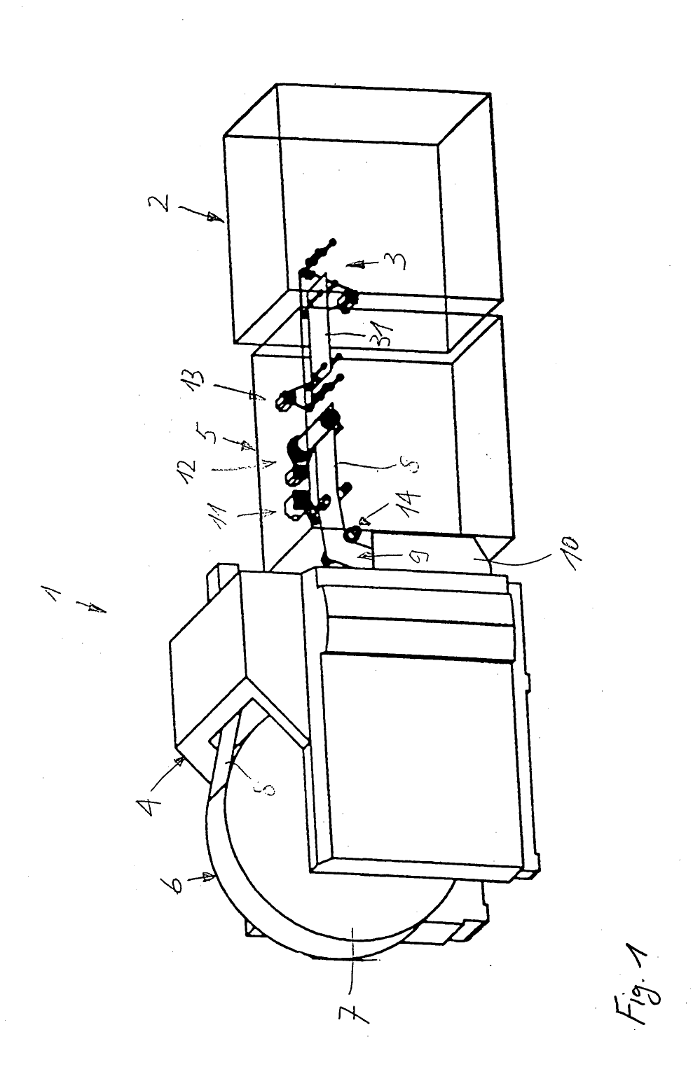

FIG. 1 shows a perspective illustration of an arrangement which is arranged upstream of a high-speed printer and is intended for feeding the high-speed printer with individual sheets,

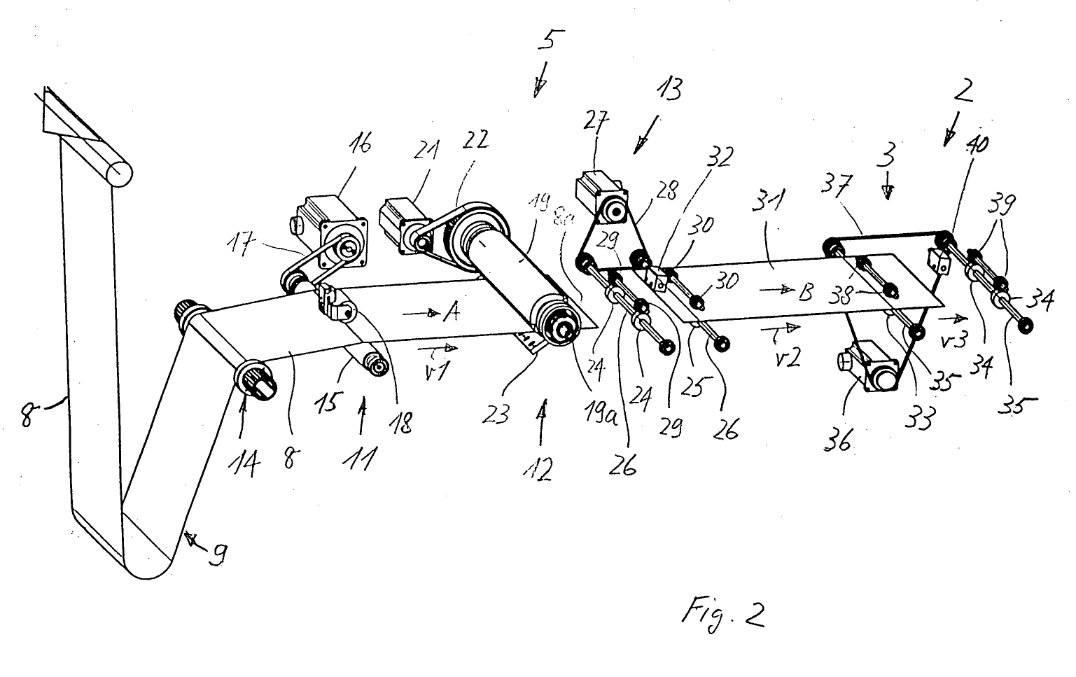

FIG. 2 shows, on a larger scale than FIG. 1, a likewise perspective illustration of the sheet-feeding unit of the arrangement according to FIG. 1,

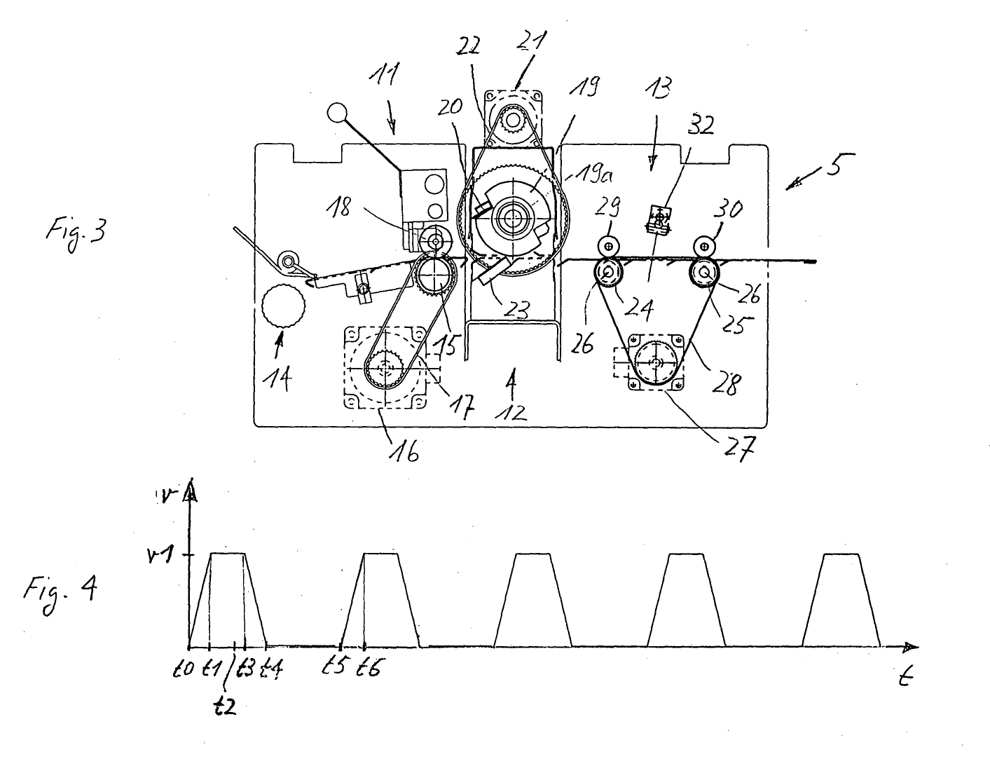

FIG. 3 shows a side view of the sheet-feeding unit according to FIG. 2, and

FIG. 4 shows a diagram illustrating the course of the advancement speed of the paper web over time.

FIG. 1 shows, schematically, an arrangement 1 for supplying individual sheets to a high-speed printer 2 (likewise only schematically illustrated), of which the sheet draw-in arrangement 3 is indicated. The high-speed printer 2, which processes individual sheets, may be, for example, a printer of the “Heidelberg Digimaster 9110”, “IBM Infoprint 2000” or “Canon imageRunner 110” type or some other high-speed printer of this type.

The supply arrangement 1 comprises an unwinding unit 4, of the construction known per se, and a sheet-feeding unit 5. A unit which is sold by Hunkeler AG, Wikon (Switzerland) under the model designation “Abwickelmodul UW4” [Unwinding module UW4] is preferably used as the unwinding unit 4. The unwinding unit 4 comprises a supply roll 7, which forms a paper-web store 6 and comprises a wound-up paper web 8. The paper roll 7 is mounted on a shaft (not visible) which is connected to a drive (not visible either). The paper web 8 unwound from the supply roll 7 is guided, before entering into the sheet-feeding unit 5, in a loop 9 (see FIG. 2) which runs in a chamber 10 belonging to the unwinding unit 4. By means of a light-barrier regulator, the position of the paper-web loop 9 is kept constant in a known manner. Instead of a light-barrier regulator, it is also possible to use a compensating-roller or dancer-roller regulator.

The sheet-feeding unit 5, which is shown schematically on an enlarged scale in FIG. 2 and in side view in FIG. 3, has an advancement arrangement 11, a separating device 12, a conveying device 13 and a web-guiding roller 14 arranged upstream of the advancement arrangement 11. The advancement arrangement 11 comprises an advancement roller 15 which is driven in circulation via a toothed belt 17 by a drive motor 16, which is preferably a stepping motor. A press-on roller 18 interacts with the advancement roller 15 and presses the paper web 8 onto the advancement roller 15.

The severing device 12 is designed as a rotary cutting device of basically conventional construction. The severing device 11 has a cutting cylinder 19 which can be rotated about its axis 19a, which runs transversely to the longitudinal extent of the paper web 8. A cutting blade 20 (see FIG. 3) is clamped into the cutting cylinder 19. The cutting cylinder 19 together with the cutting blade 20 is driven via a toothed belt 22 by a drive motor 21, which is likewise preferably a stepping motor or a servomotor operating in a stepping mode. The circulating cutting blade 20 interacts with a fixed mating blade 23. In contrast to rotary cutting machines with a moving mating blade, this has the advantage that the paper is cut in a scissor-like manner. Furthermore, there is no need for two moving parts to be synchronized with one another.

The conveying device 13 has two pairs of conveying rollers 24 and 25. The conveying rollers 24, 25 of each pair of conveying rollers are seated on a shaft 26. The shafts 26, which are parallel to one another and spaced apart from one another, are driven via a toothed belt 28 by a drive motor 27, preferably designed as a stepping motor. Pressure-exerting rollers 29, 30 interact with the respective conveying rollers 24 and 25. The pressure-exerting rollers 29, 30, together with the associated conveying rollers 24, 25, form a conveying nip for the individual sheets 31 severed from the paper web 8 by the severing device 12. Arranged between the pairs of pressure-exerting rollers 29, 30 is a sheet-monitoring element 32, which is preferably designed as a photocell and monitors the through-passage of the individual sheets 31 cut off.

FIG. 2, furthermore, illustrates the sheet draw-in arrangement 3 of the high-speed printer 2 in somewhat more detail. The sheet draw-in arrangement 3 has two pairs of transporting rollers 33 and 34. The transporting rollers 33 and 34 of each pair of conveying rollers are seated on a rotatable shaft 35. The two spaced-apart shafts 35 are driven via a toothed belt 37 by a drive motor 36, which is a stepping motor. A pressure-exerting roller 38, 39 interacts with each respective transporting roller 33, 34. The pressure-exerting rollers 38, 39 press the individual sheets 31 against the transporting rollers 33, 34 as they run through. Arranged between the pairs of pressure-exerting rollers 38, 39 is a sheet-monitoring element 40 belonging to the system control means of the high-speed printer 2.

The advancement arrangement 11 and the severing device 12 operate discontinuously, i.e. the drive motors 16 and 21 drive the respective advancement roller 15 and cutting cylinder 19 intermittently on account of the sheet requirement of the high-speed printer 2. In contrast, the conveying device 13 runs continuously, i.e. the shafts 26 with the conveying rollers 24, 25 are driven continuously by the drive motor 27 as long as the high-speed printer 2 is ready for operation. Correspondingly, when the high-speed printer 2 is ready for operation, its sheet draw-in arrangement 3 also operates continuously. The arrangement according to the invention receives control commands from the printer via an interface (not illustrated), and these control commands set the process for feeding the printer with individual sheets in operation. The arrangement according to the invention, furthermore, has a control device (not illustrated either) by means of which these control commands are processed.

The draw-in speed v3 of the high-speed printer 2, this speed being determined by the sheet draw-in arrangement 3, is critical for the advancement speed v1 of the paper web and the conveying speed v2 of the severed individual sheets 31. The conveying rollers 24, 25 of the conveying device 13 are driven at such a speed that the individual sheets 31 are moved by the conveying device 13 at a conveying speed v2, which is equal to the draw-in speed v3 of the sheet draw-in arrangement 3. The advancement roller 15 of the advancement arrangement 11 is driven at such a speed in each case that the advancement speed v1 of the paper web 8 is likewise equal to the draw-in speed v3 of the sheet draw-in arrangement 3. Correspondingly, the cutting cylinder 19 of the severing device 12 is driven at such a speed that the cutting edge of the cutting blade of the cutting cylinder 19 has a movement speed which is equal to or greater than the advancement speed v1 of the paper web 8 and thus also the draw-in speed v3 of the sheet draw-in arrangement 3.

Using the above description as a basis, and taking account of FIG. 4, which illustrates the course of the advancement speed v of the paper web 8 over time, the functioning of the supply arrangement 1 will now be explained hereinbelow.

The starting point is the state illustrated in FIG. 2, in which the advancement arrangement 11 and the severing device 12 have been brought to a standstill and the paper web 8 is at a standstill, while the conveying device 13 conveys a previously severed individual sheet 31 in the direction of the arrow B to the sheet draw-in arrangement 3, which feeds said individual sheet 31 to the printing unit of the high-speed printer 2. If the high-speed printer 2 requires a next individual sheet 31 for printing, it produces a control command, on account of which the advancement arrangement 11 is switched on at the point in time TO (FIG. 4) by virtue of the drive motor 16 being set in motion. The paper web 8 is accelerated from a standstill to the desired advancement speed v1, which is reached at the point in time t1 (FIG. 4). This advancement of the paper web 8 results in a reduction in the size of the paper-web loop 9, which leads to the light-barrier regulator responding. This causes, in a manner known per se, the paper web to unwind from the supply roll 7 by virtue of the latter rotating. As soon as the paper-web loop 9 has reached its desired position, the supply roll 7 is brought to a standstill.

Following a time delay, which depends on the length, as measured in advancement direction A of the paper web 8, of the next individual sheet 31 which is to be cut off, the drive motor 21 for the cutting cylinder is switched on at a point in time at which the paper web 8 has reached its desired advancement speed v1, e.g. at the point in time t2 (FIG. 4). At the point in time t3, at which the cutting edge of the cutting blade 20 has reached the advancement speed v1 of the paper web 8, the paper web 8 is severed as the cutting blade 20 runs past the mating blade 23, i.e. an individual sheet 31 is cut off. Once the cutting operation has taken place, both the advancement arrangement 11 and the severing device 12 are brought to a standstill. The paper web 8 is braked and continues running until it comes to a standstill at the point in time t4. This means that the stationary paper web 8 projects to a certain extent beyond the severing device 12. The distance which the paper web 8 covers during the braking operation, i.e. between t3 and t4, is always the same, with the result that the leading edge 8a of the paper web 8 always projects to the same extent beyond the cutting location, which is defined by the mating blade 23 (see FIG. 2)

The severed individual sheet 31, which is already in the region of action of the conveying device 13 at the time of the cutting operation, is conveyed to the sheet draw-in arrangement 3, by the conveying device, in conveying direction B and at the conveying speed v2, which is equal to the draw-in speed v3 of the sheet draw-in arrangement 3. The latter receives the individual sheet 31 and transports it past the sheet-monitoring element 40 to the printing unit of the high-speed printer 2. In contrast to the prior art, the severed sheet here, rather than remaining on the conveying belt, is fed directly, and with the smallest possible constant time delay, to the sheet draw-in arrangement by said conveying belt.

If the high-speed printer 2 signals that the next individual sheet 31 has to be made available (point in time t5, FIG. 4), then the paper web 8 is advanced again, as has already been described, by the advancement arrangement 11. At the point in time t6, the paper web 8 reaches its desired advancement speed v1 again. The operations of severing the next individual sheet 31 and conveying it further, then, take place in the manner already described. This also applies to the operation for preparing and feeding all following individual sheets 31.

The severing device 12 and the conveying device 13 are spaced apart in the advancement direction A of the paper web 8 by such a distance that, as the paper web 8 is advanced in each case, its leading edge 8a only comes into the region of action of the conveying device 13 when the paper web 8 has reached its desired advancement speed v1.

As has already been mentioned, the length of the individual sheets 31 can be adjusted by changing the delay time between the advancement arrangement 11 being switched on and the severing device 12 being set in operation. It is preferable for the cylinder 19 bearing the cutting blade 20 to be brought to a standstill in a defined rest position following each cutting operation.

If the format length is smaller than the circumference of the cylinder 19, the cylinder 19 can be accelerated following the cutting and brought to a standstill in the rest position before a new severing operation.

It can be gathered from what has been said above that each individual sheet 31 is severed from the paper web 8 as the latter is moving, and the severed individual sheets 31 are conveyed to the sheet feeding arrangement 3 without being braked or accelerated. This means that, at the time of the cutting operation, the paper web 8 is advanced at a speed v1, which is equal to the draw-in speed v3 of the sheet draw-in arrangement 3. The individual sheets 31, once cut off, thus already move at the sheet draw-in speed v3 and are conveyed to the sheet draw-in arrangement 3, by the conveying device 13, at the same speed v3. In addition to careful handling of the individual sheets 31, the arrangement 1 described has the advantage of a short overall length.

Following each cutting operation, the cylinder bearing the cutting blade moves back into the rest position again. Furthermore, irrespective of the format length, the leading edge of the paper web is always at the same location in relation to the severing device or the conveying device. The conveying speed of the conveying device is constant since the latter operates continuously and need not be accelerated to the draw-in speed. The time delay between the cutting operation and the point in time at which the leading sheet edge reaches the drawing-in means of the printer is thus also constant. The arrangement according to the invention is therefore adapted particularly to digital printers. These use a control command to request an individual sheet of a certain length in each case, which has to reach the drawing-in means within a certain predetermined time frame. In the case of the arrangement according to U.S. Pat. No. 3,718,394, this is not ensured since, depending on format, different numbers of individual sheets are temporarily stored on the conveying belt arranged upstream of the exposure drum.

The supply arrangement 1 described can be used to process both non-printed and pre-printed paper webs 8. In the case of pre-printed paper webs 8, it is important for the severing cut to take place precisely at the correct location. In order to ensure this, it is possible to provide a register-mark reader (not shown in the figures), by means of which the position of the cutting location can be continuously monitored and, if appropriate, corrected.

1. A method of feeding a printer (2) with individual sheets (31), the printer (2) comprising a sheet draw-in arrangement (3), which operates at a draw-in speed (v3), and produces control commands by means of which in each case one sheet is requested, the method comprising the following steps:
receiving a control command, by means of which a sheet is requested;
accelerating a paper web (8) to a desired advancement speed (v1), which is equal to the draw-in speed (v3) of the sheet draw-in arrangement (3) of the printer (2);
severing an individual sheet (31) from the paper web (8) as the paper web is moved at the desired advancement speed (v1);
directly feeding the severed individual sheet (31) to the sheet draw-in arrangement (3), the individual sheet (31) being conveyed further at a conveying speed (v2), which is likewise equal to the draw-in speed (v3) of the sheet draw-in arrangement (3) of the printer (2).

2. The method as claimed in claim 1, wherein the paper web (8) is severed by a rotary cutting device which has at least one cutting blade (20), which has a cutting edge and is clamped into a cylinder (19) which can be driven in rotation, and a mating element (23), which interacts with the cutting blade (20).

3. The method as claimed in claim 2, wherein the cylinder (19) provided with the cutting blade (20) is driven periodically at such a speed that the cutting edge of the cutting blade (20), as it comes together with the paper web (8), has a movement speed which is equal to or greater than the desired advancement speed (v1) of the paper web (8).

4. The method as claimed in claim 1, wherein the paper web (8) is drawn off from a supply roll (7).

5. The method as claimed in claim 1, wherein the advancement speed (v1) of the paper web (8) is reduced in each case following severing of an individual sheet (31) and, on account of a new control command, is increased again to the desired advancement speed (v1), which corresponds to the draw-in speed (v3) of the sheet draw-in arrangement (3).

6. The method as claimed in claim 5, wherein the paper web (8) is stopped in each case following severing of an individual sheet (31) and then is accelerated again from a standstill to the desired advancement speed (v1).

7. The method as claimed in claim 5 or 6, wherein, in relation to the point in time (t1) at which the paper web (8) reaches its desired advancement speed (v1), the severing of an individual sheet (31) is delayed by a time interval (t3-t1), the length of this time interval (t1-t3) being determined by the desired format length of the individual sheet (31) which is to be severed, the format length being measured in the conveying direction (A) of the paper web (8).

8. An arrangement for feeding a printer (2) with individual sheets (31), having a store (6) for a paper web (8), having an advancement arrangement (11) for advancing the paper web (8), having a severing device (12), which is arranged downstream of the advancement arrangement (11) and is intended for severing individual sheets (31) from the paper web (8) on account of a sheet-requesting control command, and having a conveying device (13), which is arranged downstream of the severing device (12) and is intended for feeding the severed individual sheets (31) to the sheet draw-in arrangement (3) of a printer (2), wherein the advancement arrangement (11) moves the paper web (8) to the severing device (12) at a desired advancement speed (v1), which is equal to the draw-in speed (v3) of the sheet draw-in arrangement (3) of the printer (2), wherein the severing device severs in each case one individual sheet (31) from the paper web (8) as the paper web moves at the desired advancement speed (v1), and wherein the conveying device (13) conveying the severed individual sheets (31) on directly to the sheet draw-in arrangement (3) at a conveying speed (v2), which is likewise equal to the draw-in speed (v3) of the sheet draw-in arrangement (3) of the printer (2).

9. The arrangement as claimed in claim 8, which comprises a rotatably mounted supply roll (7) which forms the paper-web store (6) and comprises a wound-up paper web (8).

10. The arrangement as claimed in claim 8, wherein the severing device (12) is a rotary cutting device which has at least one cutting blade (20), which is clamped into a cylinder (19) which can be driven in rotation, and a mating element (23), which interacts with said cutting blade.

11. The arrangement as claimed in claim 10, wherein the cylinder (19) bearing the cutting blade (20) is brought to a standstill in each case following severing of an individual sheet (31) and is set in rotation again for a new severing operation.

12. The arrangement as claimed in claim 10, wherein the mating element is a fixed mating blade (23) extending transversely to the advancement direction (A) of the paper web (8).

13. The arrangement as claimed in claim 10, wherein the cylinder (19) provided with the cutting blade (20) is driven periodically at such a speed that the cutting edge of the cutting blade (20), as it comes together with the paper web (8), has a movement speed which is equal to or greater than the advancement speed (v1) of the paper web (8).

14. The arrangement as claimed in claim 8, wherein the conveying device (13) is driven continuously.

15. The arrangement as claimed in claim 8, wherein the advancement arrangement (11) is brought to a standstill in each case following severing of an individual sheet (31) and is switched on again on account of a new sheet-requesting control command.

16. The arrangement as claimed in claim 10, wherein the advancement arrangement (11) is brought to a standstill in each case following severing of an individual sheet (31) and is switched on again on account of a new sheet-requesting control command, and wherein the cylinder (19) bearing the cutting blade (20) is set in rotation from a standstill with a time delay in each case in relation to the point in time (t1) at which the paper web (8) reaches its desired advancement speed (v1).

17. The arrangement as claimed in claim 10, wherein the cylinder (19) bearing the cutting blade (20) is accelerated following the cutting and is brought to a standstill prior to a new severing operation.

18. The arrangement as claimed in claim 10 having a non-mechanically operating high-speed printer (2), in particular a laser printer, which processes individual sheets (31).
